(19) United States
(12) Patent Application Publication
(10) Pub. No.: US 2005/0258731 A1
(43) Pub. Date: Nov. 24, 2005

(54) Color cathode ray tube apparatus

(75) Inventors: Hirofumi Ueno, Ibaraki-shi (JP); Yasufumi Wada, Takatsuki-shi (JP); Hiroyuki Tomoyasu, Ibaraki-shi (JP); Hiroji Morimoto, Kashihara-shi (JP); Tomonari Ishihara, Ibaraki-shi (JP); Tsutomu Takekawa, Ibaraki-shi (JP); Koji Nishiyama, Ibaraki-shi (JP)

Correspondence Address: HAMRE, SCHUMANN, MUELLER & LARSON, P.C., P.O. BOX 2902-0902, MINNEAPOLIS, MN, 55402, US

(73) Assignee: Matsushita Toshiba Picture Display Co., Ltd., Takatsuki-shi (JP)

(21) Appl. No.: 11/132,467

(22) Filed: May 19, 2005

(30) Foreign Application Priority Data
May 19, 2004 (JP) 2004-149580

(51) Int. Cl. H01J 29/50

(52) U.S. Cl. 313/414

(57) ABSTRACT

A color cathode ray tube apparatus includes: a valve; a phosphor screen; an electron gun including an electron beam generating portion for generating three electron beams, a focusing electrode, an anode electrode, a first field correction electrode and a second field correction electrode; and a deflector for deflecting the electron beams emitted from the electron gun, wherein the focusing electrode, the first field correction electrode, the anode electrode and the second field correction electrode form an electron lens having a focusing force in a vertical direction, which is perpendicular to the horizontal direction, stronger than its focusing force in the horizontal direction inside the focusing electrode, and having a diverging force in the vertical direction greater than its diverging force in the horizontal direction inside the anode electrode, by applying a focus voltage to the focusing electrode and the first field correction electrode and applying an anode voltage higher than the focus voltage to the anode electrode and the second field correction electrode.

### BACKGROUND OF THE INVENTION

1. Field of the Invention

The present invention relates to color cathode ray tube apparatuses. In particular, the invention relates to electron guns suitable for color cathode ray tube apparatuses.

2. Description of the Related Art

A typical conventional color cathode ray tube apparatus will be described with reference to FIG. 11. FIG. 11 is a horizontal cross-sectional view showing the overall structure of the color cathode ray tube apparatus. As shown in FIG. 11, the color cathode ray tube apparatus is provided with a valve made up of a panel 1 and a funnel 2 that are bonded integrally, and a shadow mask 3, a phosphor screen 4 and an electron gun 6 that are disposed in the inner space of the valve. Furthermore, a deflection yoke 8 is provided at an outer circumference of the valve. The phosphor screen 4 includes three color phosphor layers formed on the inner surface of the panel 1 for emitting red, green and blue light, respectively. The electron gun 6 is disposed in the inner space of a neck 5 of the funnel 2, and emits three electron beams (an electron beam 7B for the blue phosphor layer, an electron beam 7G for the green phosphor layer and an electron beam 7R for the red phosphor layer) toward the phosphor screen 4. The shadow mask 3 is disposed opposite to the phosphor screen 4 and spaced at a predetermined interval. A color image is displayed on the phosphor screen 4 by deflecting the three electron beams (7B, 7G and 7R) emitted from the electron gun 6 with the magnetic field generated by the deflection yoke 8, and scanning the phosphor screen 4 horizontally and vertically.

Among such color cathode ray tube apparatuses, commonly used is an in-line type color cathode ray tube apparatus for letting the three electron beams self-converge that includes, as the electron gun 6, an in-line type electron gun that emits three in-line electron beams consisting of a center beam and a pair of side beams and traveling on the same horizontal plane, and also includes, as the deflection yoke 8, a deflection yoke that generates a non-uniform magnetic field (self convergence magnetic field) including a pincushion-shaped magnetic field as the horizontal deflection magnetic field and a barrel-shaped magnetic field as the vertical deflection magnetic field.

There are various types of in-line type electron guns, and one is an electron gun called the BPF (bi-potential focus) type. There also are various types of the main lens structures for the in-line type electron guns, and one is called the superimposed field type. Here, the structure of a typical conventional BPF type electron gun including a superimposed field type main lens will be described with reference to FIGS. 12 to 15.

FIG. 12A shows a schematic horizontal cross-sectional view of the overall structure of the conventional electron gun, and FIG. 12B shows a schematic vertical cross-sectional view thereof. As shown in FIGS. 12A and 12B, the typical conventional BPF type electron gun includes a first grid 111, a second grid 112, a third grid 113 and a fourth grid 114 that are disposed successively in the direction from three in-line cathodes 117 to the phosphor screen (in the rightward direction in FIGS. 12A and 12B).

An electron beam is emitted from each of the three cathodes 117. Three electron beam passage apertures 118 corresponding to the three electron beams emitted from the above-described three in-line cathodes 117 are formed in the first grid 111. Similarly, three electron beam passage apertures 128 corresponding to the three electron beams emitted from the above-described three in-line cathodes 117 are formed in the second grid 112. The cathodes 117, the first grid 111 and the second grid 112 constitute a three-electrode portion that generates electron beams and that forms a virtual object point with respect to the main lens.

In the third grid 113, three electron beam passage apertures are formed at an end portion on the side from which the electron beams enter (entrance side), that is, at the portion opposite to the second grid 112, and an electron beam passage aperture common to all the three electron beams is formed at an end portion on the side from which the electron beams exit from the third grid 113 (exit side), that is, at the portion opposite to the fourth grid 114. FIG. 13 is a schematic semi-transparent perspective view showing a portion of the structure of the third grid that is at the downstream side of the beams. As shown in FIG. 13, an oblong electron beam passage aperture common to the three electron beams and having a major axis in the direction in which the three electron beams are arranged is formed at an end portion on the exit side of the third grid 113.

As shown in FIG. 13, a field correction electrode 125 having three electron beam passage apertures 148B, 148G and 148R formed therein is disposed inside the third grid 113.

In the fourth grid 114, an electron beam passage aperture common to the three electron beams is formed at an end portion on the side from which the electron beams enter (entrance side), that is, at the portion opposite to the third grid 113, and three electron beam passage apertures are formed at an end portion on the side from which the electron beams exit (exit side). FIG. 14 is a schematic semi-transparent perspective view showing a portion of the structure of the fourth grid that is at the downstream side of the beams. As shown in FIG. 14, an oblong electron beam passage aperture common to the three electron beams and having a major axis in the direction in which the three electron beams are arranged is formed at an end portion on the entrance side of the fourth grid 114.

As shown in FIG. 14, a field correction electrode 126 having three electron beam passage apertures 188B, 188G and 188R formed therein is disposed inside the fourth grid 114. In general, the electron beam passage apertures common to the three electron beams that are formed in the third grid 113 and the fourth grid 114 are formed in the same shape.

In this electron gun, the first grid 111 is applied with a voltage lower than that applied to the cathodes 117, the second grid 112 is applied with a voltage higher than that applied to the first grid 111, the third grid 113 is applied with a voltage higher than that applied to the second grid 112, and the fourth grid 114 is applied with a voltage higher than that applied to the third grid 113. For example, a voltage of about 50 V to 100 V is applied to the cathodes 117, the first grid 111 is grounded electrically (0 V), a voltage of about 600 V is applied to the second grid 112, a voltage of about 8 kV is applied to the third grid 113, and a high voltage of about 30 kV is applied to the fourth grid 114.

From a view point of electron optics, in this electron gun, a pre-focus lens for pre-focusing the electron beams emitted from the three-electrode portion is formed by the second grid 112 and the third grid 113, whereas a superimposed field type BPF main lens for focusing the electron beams eventually on the phosphor screen 4 is formed by the third grid 113, the field correction electrode 125, the fourth grid 114 and the field correction electrode 126.

In the case of this configuration, each of the portions of the third grid 113 and the fourth grid 114 that are opposite to each other, that is, an end portion on the exit side of the third grid 113 and an end portion on the entrance side of the fourth grid 114 have an opening (the electron beam passage aperture) having a length in the horizontal direction greater than its length in the vertical direction, so that the electric field penetrates into the third grid 113 side and the fourth grid 114 side. The electric field penetrated into the third grid 113 side forms an electron lens having a focusing force in the horizontal direction weaker than its focusing force in the vertical direction. However, as shown in FIG. 13, the field correction electrode 125 has the longitudinally elongated electron beam passage apertures 148R, 148G and 148B having a maximum opening dimension in the vertical direction larger than their maximum opening dimension in the horizontal direction, thus performing an electric field correction in which the focusing force in the vertical direction is reduced relatively significantly with respect to the focusing force in the horizontal direction. Accordingly, an electron lens whose focusing force in the horizontal direction and whose focusing force in the vertical direction substantially are the same eventually is formed inside the third grid 113. The focusing force of the electric field that results from the opening of the third grid 113 is different between the center beam and the side beams of the three in-line arranged electron beams. To compensate this, in general, the opening ratio (maximum opening diameter in the vertical direction/maximum opening diameter in the horizontal direction) of each of the electron beam passage apertures 148R and 148B is rendered smaller than the opening ratio of the electron beam passage aperture 148G in the field correction electrode 125 inside the third grid 113, as shown in FIG. 13.

On the other hand, the electric field penetrated into the fourth grid 114 side forms an electron lens having a diverging force in the horizontal direction weaker than its diverging force in the vertical direction. However, as shown in FIG. 14, the field correction electrode 126 has the longitudinally elongated electron beam passage apertures 188R, 188G and 188B having a maximum opening dimension in the vertical direction larger than their maximum opening dimension in the horizontal direction, thus performing an electric field correction in which the diverging force in the vertical direction is reduced relatively significantly with respect to the diverging force in the horizontal direction. Accordingly, an electron lens whose diverging force in the horizontal direction and whose diverging force in the vertical direction substantially are the same eventually is formed inside the fourth grid 114. Similarly, the phenomenon in which different diverging forces are exerted on the center beam and the side beams of the three in-line arranged electron beams occurs in this electron lens. To compensate this, in general, the opening ratio of each of the electron beam passage apertures 188R and 188B is rendered smaller than the opening ratio of the electron beam passage aperture 188G in the field correction electrode 126 inside the fourth grid 114, as shown in FIG. 14.

In order to improve the image quality of a color cathode ray tube apparatus, it is desired to achieve excellent focusing properties on the phosphor screen, that is, to reduce the spot diameters of the electron beams in the horizontal and vertical directions in the entire area on the phosphor screen. On the phosphor screen, the spot diameters of the electron beams in the horizontal and vertical directions become largest in the peripheral area, and the increase of the spot diameters in this peripheral area has been the biggest cause of inducing image degradation. Accordingly, reducing the increase of the spot diameters in the horizontal and vertical directions in the peripheral area on the phosphor screen is an effective way to improve the image quality. In addition, on the phosphor screen, each electron beam is constituted by a core and a haze. FIG. 15 is a schematic plan view showing the spot shape of electron beams on the phosphor screen. A haze (the dotted line in the FIG. 15) of an electron beam as shown in FIG. 15 is generated owing to deflection aberration that occurs when the electron beam passes through the deflection magnetic field generated in the deflection yoke, so that its generation is pronounced in the peripheral area on the phosphor screen. In addition, the haze is generated such that the spot diameter in the vertical direction (the direction of the vertical axis) with respect to the core (the solid line in FIG. 15) is increased. Accordingly, the generation of the haze has been a main cause of inducing image degradation.

Recently, the following method is known as a method for decreasing the spot diameter of electron beams in the peripheral area on the phosphor screen. That is, a horizontal just focus voltage, which is applied when an electron beam perfectly is focused in the horizontal direction in the central area on the phosphor screen, is set higher within the range from 1000 V to 100 V than a vertical just focus voltage, which is applied when an electron beam perfectly is focused in the vertical direction in the central area on the phosphor screen, and the intermediate voltage between the horizontal just focus voltage and the vertical just focus voltage is applied as a focus voltage at the time of operation. With this method, the focus degradation caused by the deflection aberration that occurs when an electron beam has reached the peripheral area on the phosphor screen can be spread over the entire phosphor screen, thus suppressing a local focus degradation on the phosphor screen. However, as shown in FIG. 15, the beam spot of an electron beam obtained solely with this method has a horizontally elongated core and a haze generated above and below the core in the peripheral area on the phosphor screen, and a further improvement therefore has been desired.

As a method for decreasing the spot diameter of electron beams in the peripheral area on the phosphor screen, it has been known to reduce the spot diameter in the vertical direction of electron beams passing through the deflection magnetic field so as to minimize the influence by the deflection aberration in the deflection yoke. With this method, the vertical haze generated in an electron beam spot by the deflection magnetic field in the peripheral area on the phosphor screen can be reduced. A specific example of the configuration for realizing this will be described with reference to FIG. 16. FIG. 16 is a schematic perspective view showing the structure of a second grid. In general, the second grid 112, which forms a pre-focus lens, includes recesses 129 at the periphery of the electron beam passage apertures 128, as shown in shown in FIG. 16. In the case of this configuration, it is required to decrease as much as possible the spot diameter in the vertical direction of electron beams entering the main lens from the electron gun side, resulting in more severe limitations on the electron beams. Moreover, this method cannot achieve improvement for the spot diameter of electron beams in the horizontal direction.

As a method for decreasing the spot diameter of electron beams in the horizontal direction on the phosphor screen, it generally is known to increase the effective lens diameter of the main lens in the horizontal direction. As a method for increasing the effective lens diameter of the main lens in the horizontal direction, it is known to render the diverging force of the main lens in the horizontal direction weaker than its diverging force in the vertical direction in the vicinity of an exit from which the electron beam exits from the main lens by disposing a field correction electrode forming a quadrupole lens in the vicinity of the exit, thereby increasing the effective lens diameter of the main lens in the horizontal direction (see e.g., JP2001-357796A). However, with this method, a horizontal just focus voltage, which is applied when an electron beam is focused perfectly in the horizontal direction in the central area on the phosphor screen, is increased, increasing the difference between the horizontal just focus voltage and a vertical just focus voltage, which is applied when the electron beam is focused perfectly in the vertical direction in the central area on the phosphor screen. Consequently, the spot diameter of the electron beam in the vertical direction is increased, so that the image quality cannot be improved. In order to reduce the difference between the horizontal just focus voltage and the vertical just focus voltage of electron beams, for example, a method is available that allows electron beams to pass through a quadruple lens before they enter the main lens. However, it is necessary to provide an additional electrode for forming the quadrupole lens, and to provide an additional configuration for supplying a potential to the additional electrode, leading to a cost increase. Furthermore, even if the difference between the horizontal and vertical focus voltages of electron beams is set in the range from 100 V to 1000 V or less by disposing a quadrupole lens in advance of the main lens in accordance with this method, and thereby the effective diameter of the main lens in the horizontal direction is increased, the effective diameter of the main lens in the vertical direction is reduced significantly. Accordingly, the vertical lens aberration is increased, increasing the spot diameter of the electron beams in the vertical direction.

As a method for solving the problem of the increased spot diameter of electron beams in the vertical direction that is generated when using the technique disclosed in JP2001-357796A, it is known to increase the diameter of the virtual object point in the horizontal direction and to decrease the diameter of the virtual object point in the vertical direction by forming the electron beam passage apertures of a control electrode in the shape of a rectangle having a length in the horizontal direction greater than its length in the vertical direction and by forming the electron beam passage apertures of an accelerating electrode through which the electron beams pass in the shape of a circle (see e.g., JP H10-289671A). With this method, it is possible to suppress the increase of the spot diameter of the electron beams in the horizontal direction. However, when the diameter of the virtual object point in the horizontal direction and the diameter of the virtual object point in the vertical direction are determined in accordance with the difference between the effective lens diameter of the main lens in the horizontal direction and the effective lens diameter of the main lens in the vertical direction, this method leads to an excessive increase in the spot diameter in the horizontal direction of the electron beams entering the main lens, so that the electron beams easily can impinge on the control electrode having the electron beam passage apertures, deteriorating the withstand voltage characteristics. Furthermore, the brightness of the color cathode ray tube apparatus cannot be increased sufficiently, since the current generated by electron beams cannot be increased sufficiently if the electron beams easily can impinge on the various electrodes. On the contrary, if the difference between the length of the electron beam passage apertures in the horizontal direction and their length in the vertical direction in the control electrode is reduced in order to ensure a spot diameter of the electron beams that is sufficiently small to prevent the electron beams from impinging on the control electrode, it is not possible to solve the problem of the increased spot diameter of the electron beams in the vertical direction on the phosphor screen. That is, with this method, it is not possible to increase the effective lens diameter of the main lens in the horizontal direction, while forming optimum electron beams for the main lens having a reduced effective lens diameter in the vertical direction at the same time.

As described above, in order to achieve an excellent image quality for the color cathode ray tube apparatus, it is necessary to decrease the spot diameters of electron beams in the horizontal and vertical directions in the entire area on the phosphor screen. However, even using the above-described conventional techniques, it has been difficult to decrease both of the spot diameter in the horizontal direction and the spot diameter in the vertical direction of electron beams at the same time.

### SUMMARY OF THE INVENTION

Therefore, the present invention improves the image quality of the color cathode ray tube apparatus by using electron beams whose spot diameter in the horizontal direction and whose spot diameter in the vertical direction both do not increase locally in the entire area on the phosphor screen, and having a spot diameter in the horizontal direction smaller than the conventional spot diameter of electron beams.

In order to solve the above-described problems, a color cathode ray tube apparatus according to the present invention includes: a valve including a face panel and a funnel; a phosphor screen disposed on an inner surface of the face panel; an electron gun disposed inside the valve and including an electron beam generating portion for generating three electron beams consisting of a center electron beam and a pair of side electron beams that are arranged in a horizontal direction, a focusing electrode and an anode electrode that are disposed in this order from the electron beam generating portion side along a traveling direction of the three electron beams, a first field correction electrode disposed inside the focusing electrode, and a second field correction electrode disposed inside the anode electrode; and a deflector disposed at an outer circumference of the funnel for deflecting the three electron beams emitted from the electron gun. The focusing electrode has a tubular structure including, at an end portion on the anode electrode side, a noncircular aperture common to the three electron beams and having a major axis in the horizontal direction and a minor axis in a vertical direction. The anode electrode includes a tubular structure having, at an end portion on the focusing electrode side, a noncircular aperture common to the three electron beams and having a major axis in the horizontal direction and a minor axis in the vertical direction. The focusing electrode, the first field correction electrode, the anode electrode and the second field correction electrode form a main lens having a focusing force in the vertical direction stronger than its focusing force in the horizontal direction inside the focusing electrode, and a diverging force in the vertical direction stronger than its diverging force in the horizontal direction inside the anode electrode, by applying a focus voltage to the focusing electrode and the first field correction electrode and applying an anode voltage higher than the focus voltage to the anode electrode and the second field correction electrode, the main lens focusing the three electron beams on the phosphor screen.

With the color cathode ray tube apparatus of the present invention, it is possible to achieve excellent focusing properties on the entire surface of the phosphor screen, without generating any electron beam spot that is deteriorated significantly on the phosphor screen.

### BRIEF DESCRIPTION OF THE DRAWINGS

FIG. 1A is a schematic horizontal cross-sectional view showing the structure of an electron gun according to Embodiment 1, and FIG. 1B is a schematic vertical cross-sectional view showing the structure of the electron gun according to Embodiment 1.

FIG. 2 is a schematic perspective view showing the structure of a first grid in the electron gun according to Embodiment 1.

FIG. 3 is a schematic perspective view showing the structure of a second grid in the electron gun according to Embodiment 1.

FIG. 4 is a schematic semi-transparent perspective view showing a portion of the structure of a third grid and a first field correction electrode in the electron gun according to Embodiment 1.

FIG. 5 is a schematic semi-transparent perspective view showing a portion of the structure of a fourth grid and a second field correction electrode in the electron gun according to Embodiment 1.

FIG. 6 is a schematic plan view showing the spot shape of electron beams on a phosphor screen in a color cathode ray tube apparatus according to Embodiment 1.

FIG. 7A is a schematic horizontal cross-sectional view showing the structure of an electron gun according to Embodiment 2, and FIG. 7B is a schematic vertical cross-sectional view showing the structure of the electron gun according to Embodiment 2.

FIG. 8 is a schematic semi-transparent perspective view showing a portion of the structure of a fourth grid and a second field correction electrode in the electron gun according to Embodiment 2.

FIG. 9 is a schematic perspective view showing the structure of a second grid of an electron gun according to a modification of the present invention.

FIG. 10 is a schematic perspective view showing a portion of the structure of a third grid in an electron gun according to a modification of the present invention.

FIG. 11 is a schematic horizontal cross-sectional view showing the overall structure of a conventional color cathode ray tube apparatus.

FIG. 12A is a schematic horizontal cross-sectional view of the overall structure of a conventional electron gun, and FIG. 12B is a schematic vertical cross-sectional view of the overall structure of the conventional electron gun.

FIG. 13 is a schematic semi-transparent perspective view showing a portion of the structure of a third grid in the conventional electron gun.

FIG. 14 is a schematic semi-transparent perspective view showing a portion of the structure of a fourth grid in the conventional electron gun.

FIG. 15 is a schematic plan view showing the spot shape of electron beams on a phosphor screen in a conventional color cathode ray tube apparatus.

FIG. 16 is a schematic perspective view showing the structure of a second grid in a conventional electron gun.

### DESCRIPTION OF THE PREFERRED EMBODIMENTS

As described above, a color cathode ray tube apparatus according to the present invention includes: a valve having a face panel and a funnel; a phosphor screen; an electron gun; and a deflector for deflecting an electron beam emitted from the electron gun. Since the feature of the present invention lies in the electrode configuration of the electron gun, only the configuration of the electron gun will be described below. It should be noted that the rest of the components may have any known or desired configurations.

An electron gun according to the present invention includes, as a main lens, an electron lens that is provided with a focusing force in a vertical direction, which is perpendicular to the horizontal direction, stronger than its focusing force in the horizontal direction inside the focusing electrode, and a diverging force in the vertical direction stronger than its diverging force in the horizontal direction inside the anode electrode, by applying a focus voltage to the focusing electrode and the first field correction electrode and applying an anode voltage higher than the focus voltage to the anode electrode and the second field correction electrode. With this configuration, it is possible to increase the effective lens diameter in the horizontal direction. Accordingly, it is possible to decrease the spot diameter of the electron beams in the horizontal direction on the phosphor screen. On the other hand, although the effective lens diameter in the vertical direction decreases slightly, there will not be a significant difference between the horizontal just focus voltage and the vertical just focus voltage of the electron beams that have passed through this main lens in the central area on the phosphor screen. Accordingly, it is possible to suppress the increase of the spot diameter of the electron beams in the vertical direction that is caused by the difference between the horizontal just focus voltage and the vertical just focus voltage. It should be noted that the difference between the horizontal just focus voltage and the vertical just focus voltage readily can be optimized to 100 V to 1000 V, which are required typically, by a minor design modification to the electrode dimensions. That is, it is possible to decrease the spot diameter of the electron beams in the horizontal direction, and to suppress the local increase of the spot diameter of the electron beams in the horizontal and vertical directions in the entire region on the phosphor screen. Accordingly, it is possible to achieve an improved image quality.

The color cathode ray tube apparatus according to the present invention may have a configuration wherein the first field correction electrode is a plate-like electrode that has three apertures arranged in the horizontal direction corresponding to the three electron beams, and that is disposed inside the focusing electrode so as to be parallel to a plane having the traveling direction of the three electron beams as a normal line. Of the three apertures in the first field correction electrode, each of the two side apertures corresponding to the pair of side electron beams has a noncircular shape having a maximum opening dimension in the horizontal direction larger than its maximum opening dimension in the vertical direction. When a ratio of the maximum opening diameter in the vertical direction to the maximum opening diameter in the horizontal direction is referred to as an opening ratio, the opening ratio of each of the two side apertures is smaller than that of the center aperture of the three apertures in the first field correction electrode that corresponds to the center electron beam. With this configuration, a penetrating electric field that is sharper in the vertical direction than in the horizontal direction can be formed, so that it is possible to form, inside the focusing electrode, a focusing lens that is common to the three electron beams and that includes a quadrupole having a focusing force in the vertical direction stronger than its focusing force in the horizontal direction. Furthermore, it is possible to reduce the difference between the electric field exerted on the center beam and the electric field exerted on the pair of side beams.

The color cathode ray tube apparatus according to the present invention may have a configuration wherein the second field correction electrode is constituted by a pair of plate-like electrodes disposed inside the anode electrode so as to be parallel to the horizontal direction and to a plane including the traveling direction of the three electron beams, and the three electron beams pass between the pair of plate-like electrodes. With this configuration, it is possible to form the above-described focusing lens. With this configuration, a penetrating electric field that is sharper in the vertical direction than in the horizontal direction can be formed, so that it is possible to form, inside the anode electrode, a diverging lens that includes a quadrupole having a diverging force in the vertical direction stronger than its diverging force in the horizontal direction.

The color cathode ray tube apparatus according to the present invention may have a configuration wherein the second field correction electrode is a plate-like electrode that has three apertures arranged in the horizontal direction corresponding to the three electron beams, and that is disposed inside the anode electrode so as to be parallel to a plane having the traveling direction of the three electron beams as a normal line. Of the three apertures in the second field correction electrode, each of the two side apertures corresponding to the pair of side electron beams has a noncircular shape having a maximum opening dimension in the horizontal direction larger than its maximum opening dimension in the vertical direction. When a ratio of the maximum opening diameter in the vertical direction to the maximum opening diameter in the horizontal direction is referred to as an opening ratio, the opening ratio of each of the two side apertures is smaller than that of the center aperture of the three apertures in the second field correction electrode that corresponds to the center electron beam. With this configuration, the penetrating electric field in the vertical direction is sharper than the penetrating electric field in the horizontal direction, so that it is possible to form, inside the anode electrode, a diverging lens that includes a quadrupole having a diverging force in the vertical direction stronger than its diverging force in the horizontal direction. Furthermore, it is possible to reduce the difference between the electric field exerted on the center beam and the electric field exerted on the pair of side beams.

The color cathode ray tube apparatus according to the present invention may have a configuration wherein the electron beam generating portion of the electron gun includes a cathode electrode for emitting the three electron beams, a control electrode having three apertures corresponding to the three electron beams for controlling generation of the three electron beams in the cathode electrode, and an accelerating electrode having three apertures corresponding to the three electron beams for accelerating the three electron beams. The control electrode includes, on the accelerating electrode side, three recesses that are formed one each at a periphery of the three apertures in the control electrode. Each of the three electron beams entering the main lens is formed to have a cross section having a maximum dimension in the horizontal direction larger than its maximum dimension in the vertical direction, by applying an acceleration voltage lower than the focus voltage to the accelerating electrode and applying a control voltage lower than the acceleration voltage to the control electrode.

With this configuration, it is possible to decrease the diameter of the virtual object point in the vertical direction. If the diameter of the virtual object point in the vertical direction is decreased, the main lens has a decreased effective lens diameter in the vertical direction and a high magnification, so that it is possible to suppress the increase of the spot diameter of the electron beams in the vertical direction. On the other hand, although the diameter of the virtual object point in the horizontal direction increases, the lens magnification increases with the increase of the effective lens diameter of the main lens in the horizontal direction. Accordingly, the increase of the spot diameter of the electron beams in the horizontal direction also can be suppressed. Furthermore, with this configuration, the beam diameter in the vertical direction becomes smaller than the beam diameter in the horizontal direction at the cross section of the electron beams, so that it is possible to minimize the disadvantage of a decreased effective lens diameter of the main lens in the vertical direction, and to minimize the influence by the deflection aberration. In other words, it is possible to minimize the influence by the deflection aberration caused by the deflection magnetic field generated in the deflector, that is, the generation of the haze, by maintaining the beam diameter in the vertical direction of the electron beams that have passed through the main lens to be small. Accordingly, it is possible to improve the focusing properties of the electron gun further.

The color cathode ray tube apparatus according to the present invention may have a configuration wherein the control electrode is a plate-like electrode disposed parallel to a plane having the traveling direction of the three electron beams as a normal line. Each of the three apertures in the control electrode has a shape having a length in the horizontal direction greater than its length in the vertical direction. Each of the three recesses in the control electrode has a shape having a length in the vertical direction greater than its length in the horizontal direction. With this configuration, it is possible to form each of the three electron beams entering the main lens to have a cross section having a maximum diameter in the horizontal direction larger than its maximum diameter in the vertical direction.

The color cathode ray tube apparatus according to the present invention may have a configuration wherein the accelerating electrode is a plate-like electrode disposed parallel to a plane having the traveling direction of the three electron beams as a normal line. The accelerating electrode includes, on the control electrode side, three recesses that are formed one each at a periphery of the three apertures in the accelerating electrode. Each of the three recesses in the accelerating electrode has a shape having a length in the horizontal direction greater than its length in the vertical direction. With this configuration, it is possible to form each of the three electron beams entering the main lens to have a cross section having a maximum dimension in the horizontal direction larger than its maximum dimension in the vertical direction, more favorably. Furthermore, with this configuration, it is possible to decrease the divergence angle in the vertical direction, so that it is possible to suppress the increase of the spot diameter of the electron beams in the vertical direction. Furthermore, it is possible to compensate for the increased lens aberration resulting from the decreased effective lens diameter of the main lens in the vertical direction by suppressing the divergence angle of the electron beams in the vertical direction to be small. On the other hand, although the divergence angle in the horizontal direction increases, the lens aberration decreases with the increase of the effective lens diameter of the main lens in the horizontal direction. Accordingly, it also is possible to suppress the increase of the spot diameter of the electron beams in the horizontal direction. It is preferable that the divergence angle in the horizontal direction is large enough to prevent the electron beams from impinging on the various electrodes.

The color cathode ray tube apparatus according to the present invention may have a configuration wherein the accelerating electrode and the focusing electrode form a pre-focus lens having a focusing force in the vertical direction greater than its focusing force in the horizontal direction for pre-focusing the three electron beams, by applying the focus voltage to the focusing electrode and applying the acceleration voltage to the accelerating electrode. With this configuration, it is possible to form each of the three electron beams entering the main lens to have a cross section having a maximum dimension in the horizontal direction larger than its maximum dimension in the vertical direction and matching favorably with the main lens.

The color cathode ray tube apparatus according to the present invention may have a configuration wherein the accelerating electrode is a plate-like electrode disposed parallel to a plane having the traveling direction of the three electron beams as a normal line. The accelerating electrode includes, on the focusing electrode side, three recesses having a length in the horizontal direction greater than its length in the vertical direction, the three recesses being formed one each at a periphery of the three apertures in the accelerating electrode. With this configuration, it is possible to form the above-described pre-focus lens.

The color cathode ray tube apparatus according to the present invention may have a configuration wherein the focusing electrode includes three apertures corresponding to the three electron beams that are formed at an end portion on the accelerating electrode side, and includes, on the accelerating electrode side, three recesses having a length in the vertical direction greater than its length in the horizontal direction, the three recesses being formed one each at a periphery of the three apertures in the focusing electrode. With this configuration, it is possible to form the above-described pre-focus lens.

### EMBODIMENT 1

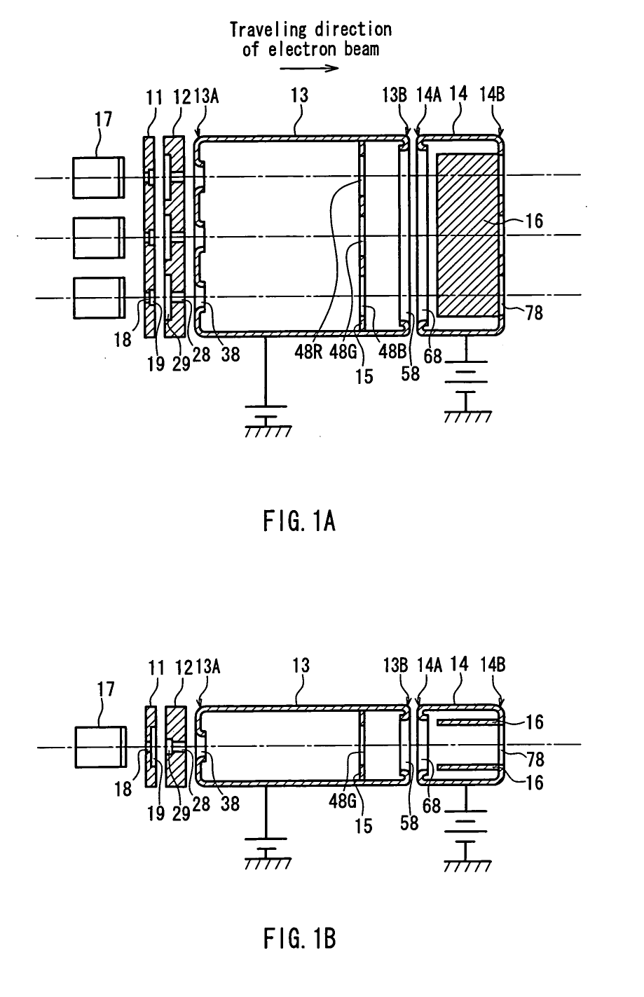

In Embodiment 1, a color cathode ray tube apparatus including an electron gun having a second field correction electrode that is constituted by a pair of plate-like electrodes disposed parallel to the horizontal direction and to a plane including the traveling direction of three electron beams and that has a configuration in which three electron beams pass between the pair of plate-like electrodes will be described with reference to FIGS. 1 to 6. It should be noted that the color cathode ray tube apparatus of this embodiment may have the same general configuration as the conventional color cathode ray tube apparatus, except for the configuration of the electron gun, and the description therefore has been omitted.

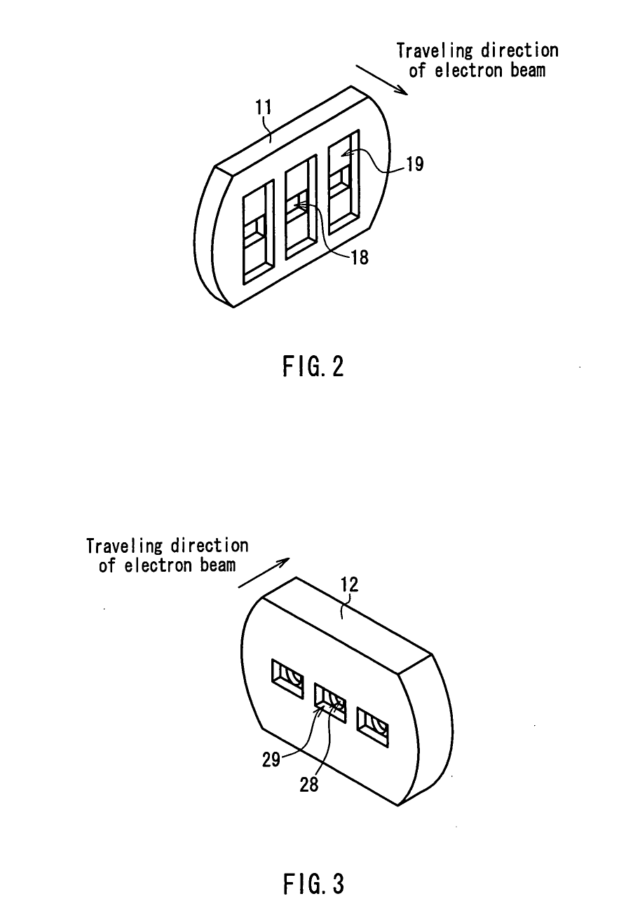

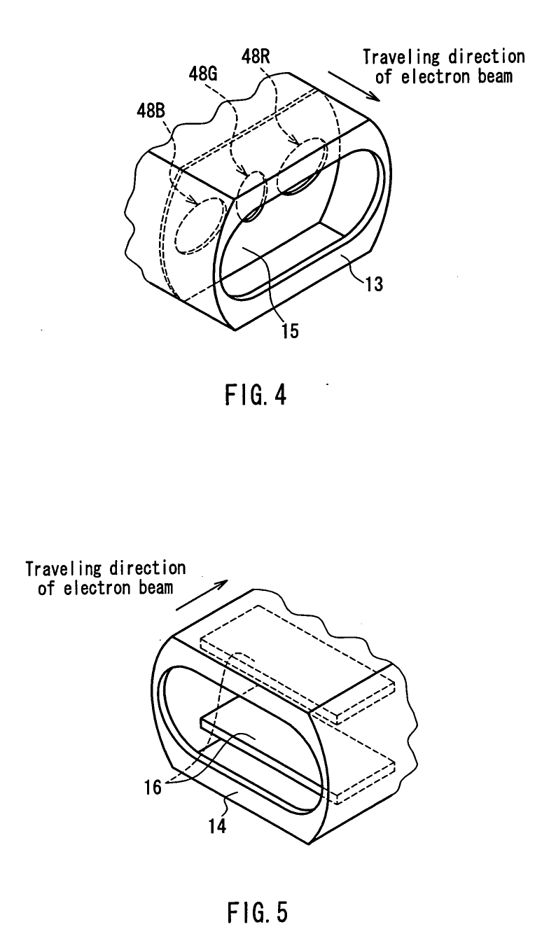

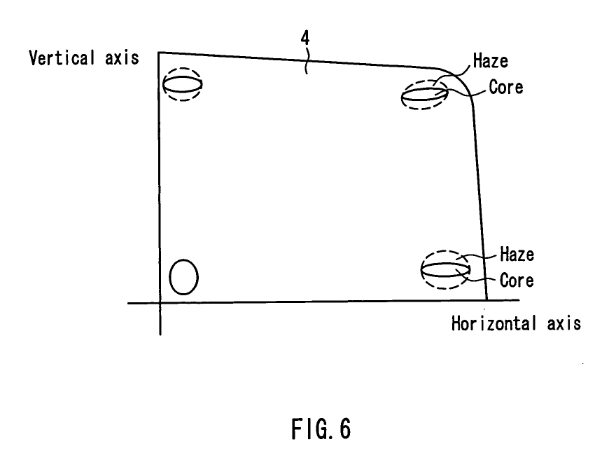

FIG. 1A is a schematic horizontal cross-sectional view showing the structure of the electron gun, and FIG. 1B is a schematic vertical cross-sectional view showing the structure of the electron gun. FIG. 2 is a schematic perspective view showing the structure of the first grid of the electron gun. FIG. 3 is a schematic perspective view showing the structure of the second grid of the electron gun. FIG. 4 is a schematic semi-transparent perspective view showing a portion of the structure of the third grid and the first field correction electrode of the electron gun. FIG. 5 is a schematic semi-transparent perspective view showing a portion of the structure of the fourth grid and the second field correction electrode of the electron gun. FIG. 6 is a schematic plan view showing the spot shape of electron beams on the phosphor screen in the color cathode ray tube apparatus.

As shown in FIGS. 1A and 1B, the electron gun according to Embodiment 1 includes three cathodes (cathode electrode) 17, a first grid (control electrode) 11, a second grid (accelerating electrode) 12, a third grid (focusing electrode) 13 and a fourth grid (anode electrode) 14.

Three electron beams consisting of a center beam and a pair of side beams arranged in the horizontal direction are generated from the three cathodes 17, respectively.

As shown in FIGS. 1A, 1B and 2, the first grid 11 is a plate-like electrode disposed parallel to a plane having the traveling direction of the electron beams as a normal line. In the first grid 11, three rectangular recesses 19 having a length in the vertical direction greater than their length in the horizontal direction are formed on the second grid 12 side, and one each electron beam passage aperture (aperture) 18 is formed in each of the three recesses 19. Additionally, each of the three electron beam passage apertures 18 is a rectangular aperture having an opening dimension in the horizontal direction larger than its opening dimension in the vertical direction. The first grid 11 has a configuration in which more electrons can be drawn from the cathodes 17 in the horizontal direction than in the vertical direction, and the diameter of the virtual object point in the horizontal direction with respect to a main lens formed by the third grid 13 and the fourth grid 14 is larger, and the diameter of the virtual object point in the vertical direction with respect to the main lens is smaller. Moreover, since the side walls of the recesses 19 are disposed adjacent to the electron beam passage apertures 18 in the horizontal direction, this configuration suppresses the excessive increase of the divergence angle of the electron beams in the horizontal direction. Furthermore, since the side walls of the recesses 19 are spaced apart from the electron beam passage aperture 18 in the vertical direction, this configuration suppresses the excessive decrease of the divergence angle of the electron beams in the vertical direction.

As shown in FIGS. 1A, 1B and 3, the second grid 12 is a plate-like electrode disposed parallel to a plane having the traveling direction of the electron beams as a normal line. In the second grid 12, three rectangular recesses 29 having a length in the horizontal direction greater than their length in the vertical direction are formed on the first grid 11 side, and one each electron beam passage aperture (aperture) 28 is formed in the three recesses 29. The second grid 12 has a configuration that increases the divergence angle in the horizontal direction and decreases the divergence angle in the vertical direction. Furthermore, the configuration decreases the dimension of the virtual object point in the horizontal direction with respect to the main lens formed by the third grid 13 and the fourth grid 14, and increases the dimension of the virtual object point in the vertical direction with respect to the main lens.

Both of the configurations of the first grid 11 and the second grid 12 are adjusted in such a manner that the dimension of the virtual object point in the horizontal direction relatively is large with respect to the diameter of the virtual object point in the vertical direction, that the divergence angle in the horizontal direction is large enough to prevent the electron beams from impinging on a portion of the various grids, and that the divergence angle in the vertical direction is small enough to reduce the influence by the deflection aberration and the influence by the increase of the effective lens diameter of the main lens. It should be noted that the change of the dimension of the virtual object point is dependent on the shape of the first grid, and the change of the divergence angle is dependent more on the second grid.

As shown in FIGS. 1A, 1B and 4, the third grid 13 is constituted by a tubular structure having, at an end portion 13A on the entrance side of the electron beams, three electron beam passage apertures 38 corresponding to the three electron beams, and an oblong electron beam passage aperture 58 common to the three electron beams and having a major axis in the horizontal direction (the direction in which the electron beams are arranged), at an end portion 13B on the exit side of the electron beams.

A first field correction electrode 15 is a plate-like electrode disposed inside the third grid 13. As shown in FIGS. 1A, 1B and 4, in the first field correction electrode 15, three electron beam passage apertures (apertures) corresponding to the three electron beams are formed so as to be arranged in the horizontal direction. Of the three apertures in the first field correction electrode 15, the two side electron beam passage apertures 48R and 48B corresponding to the pair of side electron beams have a noncircular shape having a maximum dimension in the horizontal direction larger than its maximum dimension in the vertical direction. Further, the opening ratio of each of the two side electron beam passage apertures 48R and 48B is smaller than the opening ratio of the center electron beam passage aperture 88G corresponding to the center electron beam.

As show in FIGS. 1A, 1B and 5, the fourth grid 14 is constituted by a tubular structure having, at an end portion 14A on the entrance side of the electron beams, an oblong electron beam passage aperture (aperture) 68 common to the three electron beams and having a major axis in the horizontal direction, and three electron beam passage apertures (apertures) 78 corresponding to the three electron beams, at an end portion 14B on the exit side of the electron beams.

A second field correction electrode 16 is disposed inside the fourth grid 14. As shown in FIGS. 1A, 1B and 5, the second field correction electrode 16 is constituted by a pair of plate-like electrodes (partition-like electrodes) disposed parallel to the horizontal direction and to a plane including the traveling direction of the three electron beams. The three electron beams pass between the pair of plate-like electrodes.

When the third grid 13 and the first field correction electrode 15 are applied with a focus voltage, and the fourth grid 14 and the second field correction electrode 16 are applied with an anode voltage higher than the focus voltage, the main lens becomes an electron lens having a focusing force in a vertical direction, which is perpendicular to the horizontal direction, stronger than its focusing force in the horizontal direction inside the third grid 13, and having a diverging force in the vertical direction stronger than its diverging force in the horizontal direction inside the fourth grid 14.

In the case of using an electron gun having the above-described configuration, as shown in FIG. 6, the spot diameter of the core in the horizontal direction can be smaller than that achieved by the conventional configuration shown in FIG. 16, the spot diameter of the core in the vertical direction can be equivalent to that achieved by the conventional configuration, and the spot diameter of the haze in the vertical direction can be smaller than that achieved by the conventional configuration.

Here, a more specific configuration will be described. In this specific example, the neck diameter of the funnel is φ29 mm. The first grid 11 has a thickness of 0.21 mm, and in the first grid 11, rectangular electron beam passage apertures 18 having a length in the horizontal direction of 0.70 mm and a length in the vertical direction of 0.55 mm, and rectangular recesses 19 having a length in the horizontal direction of 0.80 mm, a length in the vertical direction of 2.00 mm, and a depth of 0.14 mm are formed. The second grid 12 has a thickness of 0.70 mm, and in the second grid 12, a circular electron beam passage aperture 28 having a diameter of 0.70 mm is formed, while rectangular recesses 29 having a length in the horizontal direction of 2.00 mm, a length in the vertical direction of 0.75 mm, and a depth of 0.35 mm are formed on the first grid 11 side. In the third grid 13, an electron beam passage aperture 58 having a maximum dimension in the horizontal direction of 19.20 mm and a maximum dimension in the vertical direction of 8.20 mm is formed at the end portion 13B on the exit side of the electron beams. In the first field correction electrode 15, a center electron beam passage aperture 48G having a maximum dimension in the horizontal direction of 4.70 mm and a maximum dimension in the vertical direction of 4.80 mm, and side electron beam passage apertures 48R and 48B having a maximum dimension in the horizontal direction of 6.50 mm and a maximum dimension in the vertical direction of 4.90 mm are formed. In the fourth grid 14, an electron beam passage aperture 68 having a maximum dimension in the horizontal direction of 19.20 mm and a maximum dimension in the vertical direction of 8.20 mm is formed at the end portion 14B on the exit side of the electron beams. Furthermore, as the second field correction electrode 16, a pair of plate-like electrodes having a width of 15.00 mm and a gap between the partitions of 6.50 mm are formed. With this configuration, the difference between the horizontal just focus voltage and the vertical just focus voltage of electron beams that have reached the center of the phosphor screen can be set within the range from 100 V to 1000 V.

In the case of the electron gun of this specific example, at the time of operation, a voltage of about 150 V is applied to the cathodes 17, the first grid 11 is grounded electrically, and a voltage of about 600 V is applied to the second grid 12. A voltage of about 8 kV is applied to the third grid 13. A high voltage of about 30 kV is applied to the fourth grid 14.

### EMBODIMENT 2

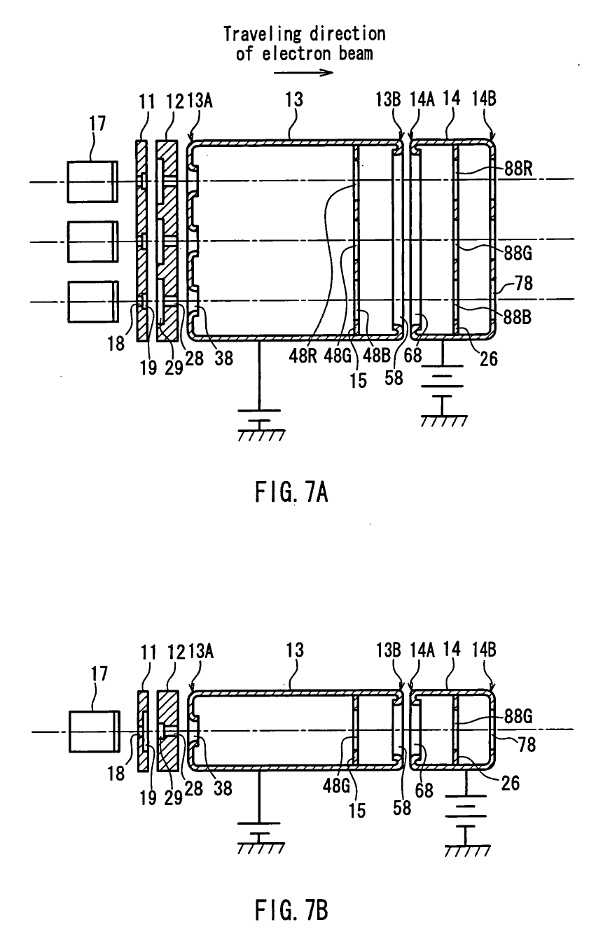

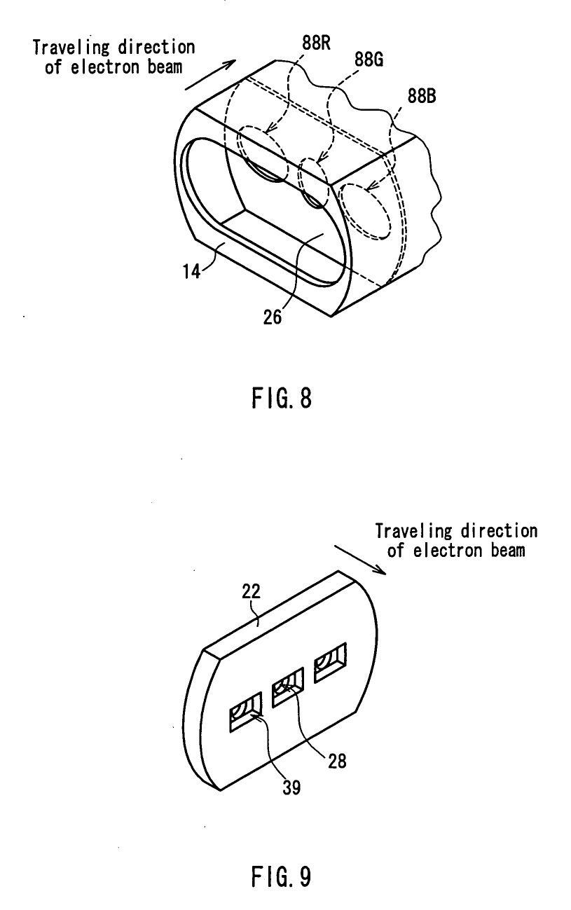

In Embodiment 2, a color cathode ray tube apparatus including an electron gun having a second field correction electrode that is a plate-like electrode having three apertures corresponding to the three electron beams will be described with reference to FIGS. 7 and 8. It should be noted that the color cathode ray tube apparatus of this embodiment has the same configuration as the color cathode ray tube apparatus of Embodiment 1 above, except for the configuration of the second field correction electrode in the electron gun. Therefore, the same structural components are given the same reference numerals and the description has been omitted.

FIG. 7A is a schematic horizontal cross-sectional view showing the structure of the electron gun, and FIG. 7B is a schematic vertical cross-sectional view showing the structure of the electron gun. FIG. 8 is a schematic semi-transparent perspective view showing a portion of the structure of the fourth grid and the second field correction electrode.

A second field correction electrode 26 is a plate-like electrode disposed inside the fourth grid 14. As shown in FIGS. 7A, 7B and 8, in the second field correction electrode 26, three electron beam passage apertures (apertures) 88R, 88G and 88B corresponding to the three electron beams are formed so as to be arranged in the horizontal direction. Of the three apertures in the second field correction electrode 26, the two side electron beam passage apertures 88R and 88B corresponding to the pair of side electron beams have a noncircular shape having a maximum dimension in the horizontal direction larger than its maximum dimension in the vertical direction. Furthermore, the opening ratio of each of the two side electron beam passage apertures 88R and 88B is smaller than the opening ratio of the center electron beam passage aperture 88G corresponding to the center electron beam.

Specifically, in the second field correction electrode 26, a center electron beam passage aperture 48G having a maximum dimension in the horizontal direction of 4.70 mm and a maximum dimension in the vertical direction of 4.80 mm, and side electron beam passage apertures 48R and 48B having a maximum dimension in the horizontal direction of 6.5 mm and a maximum dimension in the vertical direction of 4.9 mm are formed.

As in Embodiment 1 described above, when the third grid 13 and the first field correction electrode 15 are applied with a focus voltage, and the fourth grid 14 and the second field correction electrode 26 are applied with an anode voltage higher than the focus voltage, the main lens becomes an electron lens having a focusing force in a vertical direction, which is perpendicular to the horizontal direction, stronger than its focusing force in the horizontal direction inside the third grid 13, and having a diverging force in the vertical direction stronger than its diverging force in the horizontal direction inside the fourth grid 14. Accordingly, it is possible to achieve the same effect as in Embodiment 1 above.

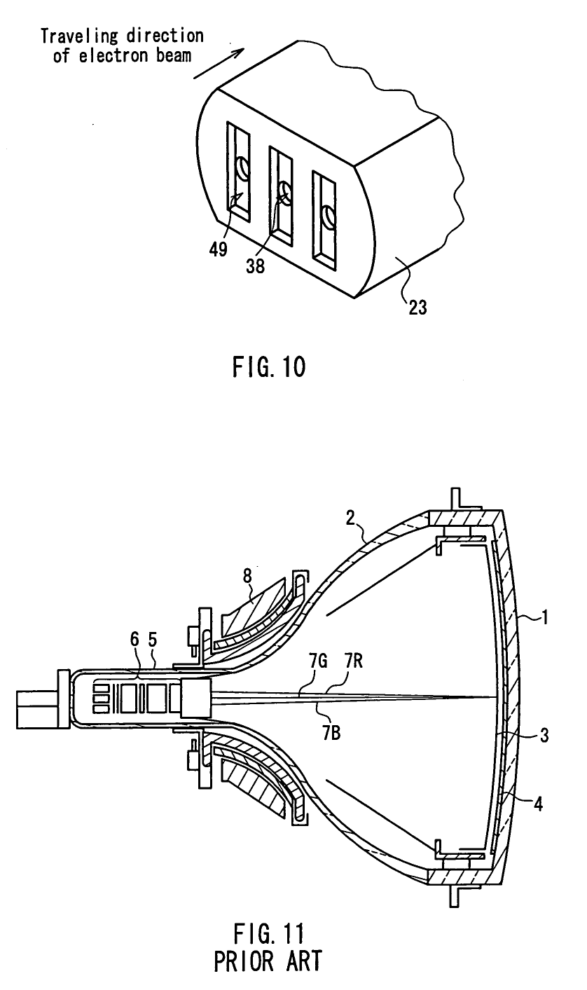

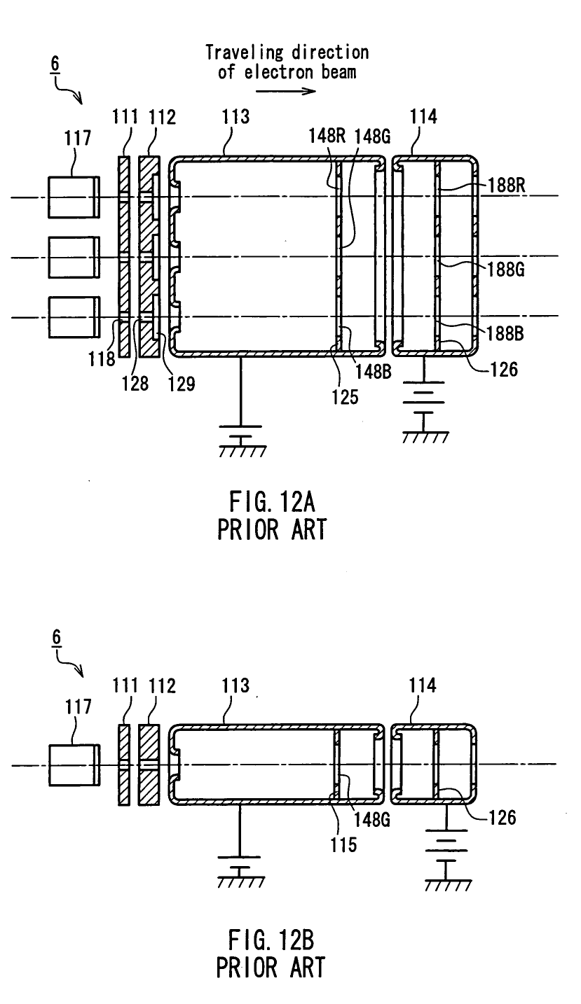

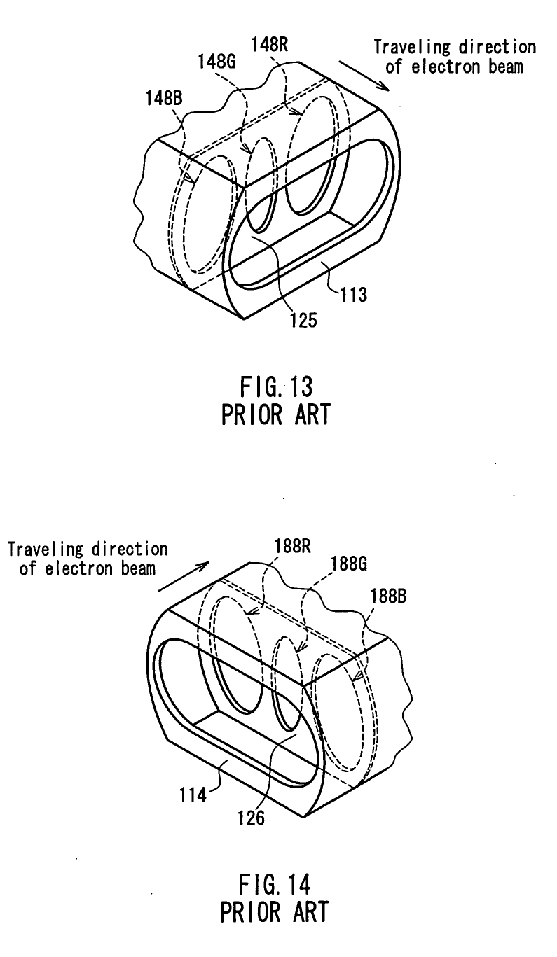

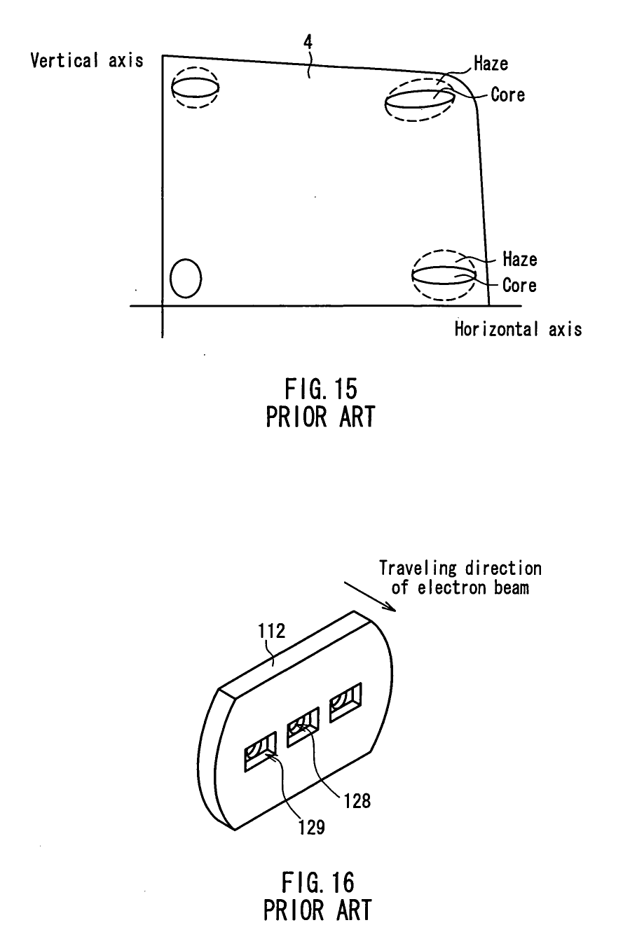

Here, a color cathode ray tube apparatus having a configuration different from those of Embodiments 1 and 2 above will be described with reference to FIGS. 9 and 10. FIG. 9 is a schematic perspective view showing the structure of the second grid in an electron gun according to a first modification. FIG. 10 is a schematic perspective view showing the structure of the third grid of an electron gun according to a second modification.

In Embodiments 1 and 2 described above, the recesses 29 in the second grid 12 are disposed on the first grid 11 side, as shown in FIGS. 1A, 1B, 7A and 7B. However, as shown in FIG. 9, recesses 39 having a length in the horizontal direction greater than their length in the vertical direction may be disposed on the third grid 13 side, in place of the recesses 29 (the first modification). Also with this configuration, it is possible to form astigmatism in which the focusing force of the pre-focus lens in the vertical direction is stronger than its focusing force in the horizontal direction, so that it is possible to achieve the same effect as in Embodiments 1 and 2 above.

Furthermore, in Embodiments 1 and 2 described above, only the three electron beam passage apertures 38 are disposed at the end portion 13A on the entrance side of the third grid 13, as shown in FIGS. 1A, 1B, 7A and 7B. However, as shown in FIG. 10, three recesses 49 having a length in the vertical direction greater than their length in the horizontal direction corresponding to the three electron beams further may be formed on the second grid side (the second modification). It should be noted that one of the three electron beam passage apertures 38 of the third grid 23 shown in FIG. 10 is formed in each of the three recesses 49. Also with this configuration, it is possible to form astigmatism in which the focusing force of the pre-focus lens in the vertical direction is stronger than its focusing force in the horizontal direction, so that it is possible to achieve the same effect as in Embodiments 1 and 2 described above.

It should be noted that in Embodiments 1 and 2 described above, the present invention is described by referring to apertures in elliptic shapes as examples, but the shape of each aperture is not limited to an elliptic shape, and the aperture may be in a noncircular shape having a maximum opening dimension or a minimum opening dimension in the horizontal direction or the vertical direction.

The present invention can be used to achieve an improved image quality by scanning the entire area on the phosphor screen in a color cathode ray tube apparatus with electron beams whose spot diameter in the horizontal direction and whose spot diameter in the vertical direction both do not increase locally, and having a spot diameter in the horizontal direction smaller than the conventional spot diameter of electron beams.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A color cathode ray tube apparatus comprising:
a valve including a face panel and a funnel;
a phosphor screen disposed on an inner surface of the face panel;
an electron gun disposed inside the valve and including an electron beam generating portion for generating three electron beams consisting of a center electron beam and a pair of side electron beams that are arranged in a horizontal direction, a focusing electrode and an anode electrode that are disposed in this order from the electron beam generating portion side along a traveling direction of the three electron beams, a first field correction electrode disposed inside the focusing electrode, and a second field correction electrode disposed inside the anode electrode; and
a deflector disposed at an outer circumference of the funnel for deflecting the three electron beams emitted from the electron gun,
wherein the focusing electrode comprises a tubular structure including, at an end portion on the anode electrode side, a noncircular aperture common to the three electron beams and having a major axis in the horizontal direction and a minor axis in a vertical direction,
wherein the anode electrode comprises a tubular structure having, at an end portion on the focusing electrode side, a noncircular aperture common to the three electron beams and having a major axis in the horizontal direction and a minor axis in the vertical direction, and
wherein the focusing electrode, the first field correction electrode, the anode electrode and the second field correction electrode form a main lens having a focusing force in the vertical direction stronger than its focusing force in the horizontal direction inside the focusing electrode, and a diverging force in the vertical direction stronger than its diverging force in the horizontal direction inside the anode electrode, by applying a focus voltage to the focusing electrode and the first field correction electrode and applying an anode voltage higher than the focus voltage to the anode electrode and the second field correction electrode, the main lens focusing the three electron beams on the phosphor screen.

2. The color cathode ray tube apparatus according to claim 1,
wherein the first field correction electrode is a plate-like electrode that has three apertures arranged in the horizontal direction corresponding to the three electron beams, and that is disposed inside the focusing electrode so as to be parallel to a plane having the traveling direction of the three electron beams as a normal line,
wherein, of the three apertures in the first field correction electrode, each of the two side apertures corresponding to the pair of side electron beams has a noncircular shape having a maximum opening dimension in the horizontal direction larger than its maximum opening dimension in the vertical direction, and
wherein, when a ratio of the maximum opening dimension in the vertical direction to the maximum opening diameter in the horizontal direction is referred to as an opening ratio, the opening ratio of each of the two side apertures is smaller than that of the center aperture of the three apertures in the first field correction electrode that corresponds to the center electron beam.

3. The color cathode ray tube apparatus according to claim 1,
wherein the second field correction electrode is constituted by a pair of plate-like electrodes disposed inside the anode electrode so as to be parallel to the horizontal direction and to a plane including the traveling direction of the three electron beams, and the three electron beams pass between the pair of plate-like electrodes.

4. The color cathode ray tube apparatus according to claim 1,
wherein the second field correction electrode is a plate-like electrode that has three apertures arranged in the horizontal direction corresponding to the three electron beams, and that is disposed inside the anode electrode so as to be parallel to a plane having the traveling direction of the three electron beams as a normal line,
wherein, of the three apertures in the second field correction electrode, each of the two side apertures corresponding to the pair of side electron beams has a noncircular shape having a maximum opening dimension in the horizontal direction larger than its maximum opening dimension in the vertical direction, and
wherein, when a ratio of the maximum opening dimension in the vertical direction to the maximum opening dimension in the horizontal direction is referred to as an opening ratio, the opening ratio of each of the two side apertures is smaller than that of the center aperture of the three apertures in the second field correction electrode that corresponds to the center electron beam.

5. The color cathode ray tube apparatus according to claim 1,
wherein the electron beam generating portion of the electron gun comprises a cathode electrode for emitting the three electron beams, a control electrode having three apertures corresponding to the three electron beams for controlling generation of the three electron beams in the cathode electrode, and an accelerating electrode having three apertures corresponding to the three electron beams for accelerating the three electron beams,
wherein the control electrode includes on the accelerating electrode side, three recesses that are formed one each at a periphery of the three apertures in the control electrode, and
wherein each of the three electron beams entering the main lens is formed to have a cross section having a maximum dimension in the horizontal direction larger than its maximum dimension in the vertical direction, by applying an acceleration voltage lower than the focus voltage to the accelerating electrode and applying a control voltage lower than the acceleration voltage to the control electrode.

6. The color cathode ray tube apparatus according to claim 5,
wherein the control electrode is a plate-like electrode disposed parallel to a plane having the traveling direction of the three electron beams as a normal line,
wherein each of the three apertures in the control electrode has a shape having a length in the horizontal direction greater than its length in the vertical direction, and
wherein each of the three recesses in the control electrode has a shape having a length in the vertical direction greater than its length in the horizontal direction.

7. The color cathode ray tube apparatus according to claim 5,
wherein the accelerating electrode is a plate-like electrode disposed parallel to a plane having the traveling direction of the three electron beams as a normal line,
wherein the accelerating electrode includes on the control electrode side, three recesses that are formed one each at a periphery of the three apertures in the accelerating electrode, and
wherein each of the three recesses in the accelerating electrode has a shape having a length in the horizontal direction greater than its length in the vertical direction.

8. The color cathode ray tube apparatus according to claim 5,
wherein the accelerating electrode and the focusing electrode form a pre-focus lens having a focusing force in the vertical direction greater than its focusing force in the horizontal direction for pre-focusing the three electron beams, by applying the focus voltage to the focusing electrode and applying the acceleration voltage to the accelerating electrode.

9. The color cathode ray tube apparatus according to claim 5,
wherein the accelerating electrode is a plate-like electrode disposed parallel to a plane having the traveling direction of the three electron beams as a normal line, and
wherein the accelerating electrode includes on the focusing electrode side, three recesses having a length in the horizontal direction greater than its length in the vertical direction, the three recesses being formed one each at a periphery of the three apertures in the accelerating electrode.

10. The color cathode ray tube apparatus according to claim 5,
wherein the focusing electrode includes three apertures corresponding to the three electron beams that are formed at an end portion on the accelerating electrode side, and includes on the accelerating electrode side, three recesses having a length in the vertical direction greater than its length in the horizontal direction, the three recesses being formed one each at a periphery of the three apertures in the focusing electrode.
